(19) United States
(12) Patent Application Publication
(10) Pub. No.: US 2009/0140705 A1
(43) Pub. Date: Jun. 4, 2009

(54) Device for Regulating Electrical Voltage

(75) Inventor: Dieter Dohnal, Lappersdorf (DE)

Correspondence Address: K.F. ROSS P.C., 5683 RIVERDALE AVENUE, SUITE 203 BOX 900, BRONX, NY, 10471-0900, US

(73) Assignee: MASCHINENFABRIK REINHAUSEN GMBH, Regensburg (DE)

(21) Appl. No.: 11/664,364

(22) PCT Filed: Jul. 22, 2005
(86) PCT No.: PCT/EP2005/007999

§ 371 Date: Mar. 28, 2007

(30) Foreign Application Priority Data
Sep. 28, 2004 (DE) 10 2004 046 926.1

(51) Int. Cl. G05F 1/16; G05F 1/14

(52) U.S. Cl. 323/258; 323/255

(57) ABSTRACT

The invention relates to a device for regulating the electrical voltage in power mains, comprising a regulating transformer. Optionally interconnecting only three winding taps and a separate reactor winding with a total of four switching elements, enables five different voltage levels to be set.

The invention relates to a voltage regulator for power-supply lines.

In today's extensive centralized energy supply system, voltage control generally is effected by means of control transformers in the central nodes of the high or medium high voltage systems. For this purpose, the windings of the control transformers are provided with taps and it is possible to switch between adjacent winding taps without interruption under load by means of tap changers.

Generally, there exist two types of suitable tap changers: high-speed circuit breakers in which transition resistors are present and which can only be loaded during short periods of time for limiting the circuit current flowing during the switching operation and accordingly, does a rapid switching between the winding taps, as well as those of the reactor switch type in which inductive transition impedances are used giving as a result a slow and continuous switching.

In the above-described voltage control in the field of high and medium-high voltage systems, it is however not possible to easily provide local control in distribution transformers in decentralized power-supply systems.

For this control that is effected close to the consumer in decentralized power supply systems, in particular in the USA, so-called “Voltage Regulators” have become widely accepted. Most common “Voltage Regulators” are single-phase, possess inductive transition impedances that are also referred to as reactor or reactor windings and enable 32-step voltage control, each step at ⅝%, i.e. in the range of +/−10%.

A different type of “Voltage regulator” are that of the Auto Boosters® type. This device has a less complicated structure and enables forward control in four steps of respectively 2½ or 1½%, i.e. +10 or +6% in total.

A further approach for providing voltage control that is close to the consumer in the field of low voltages is described in WO 2001/033308 [US equivalents 6762594 and 692463] and WO 2003/044611 [US equivalent 20050017696]. Both applications in general are based on the object of providing a control transformer having a small number taps. Here, the individual partial windings are optionally looped by means of a changeover switch, the control transformer having a leakage impedance that is sufficient for limiting the circuit current to the order of the nominal current in the case of a short circuit of adjacent taps of the partial windings, which can occur during short periods of time when switching under load. The typical transition resistances of traditional tap changers can thus be avoided. In this arrangement, which is suitable for use as a control transformer of the autotransformer type or of a split-winding transformer type, different designs of the changeover switch are possible. Thus, it is proposed to use as changeover switch a load changeover switch of a tap changer that has no resistance contacts but only main contacts. According to other propositions, the changeover switch is designed as multiple cam stepping switch, optionally also composed of a series of relays or contactors, or finally, also consisting of a series of electronic switches, in particular thyristors. The number of possible positions thus corresponds to the number of required circuit elements of the changeover switch.

The disadvantage of this state of the art is that in particular in the case of the split-winding transformer, a separate primary and control winding must be provided. For raising the leakage inductance of each level such that the short-circuit current of the respective level only reaches the order of the nominal voltage, a short leakage channel is required. As a result a separate, short control winding is used and consequently leads to increased width and depth of the transformer. This additional expense of transformer costs is higher in many cases than gain obtained due to thus avoided transition resistances. Furthermore, the control performance is difficult; the known arrangement in particular is not suitable for parallel connections.

An object of the invention is to provide an easy and cost-efficient apparatus for regulating the electrical voltage for distribution transformers and voltage regulators that have the lowest possible number of switches.

This object is attained by an apparatus having the features of the first patent claim. The dependent claims relate to special improved designs of the invention.

The apparatus according to the invention preferably is used for the regulation of distribution transformers having a small range of regulation of for example +/−5% in steps of 2.5%, that is, in total for example five steps. The apparatus according to the invention is suitable for oil-filled transformers as well as for air-cooled transformers. The particular advantage is that only a minimum increase of the dimensions of the respective distribution transformer is required and a high usability and operational reliability are ensured. This is due to the fact that the apparatus according to the invention is designed as a switching apparatus that does not require the mechanically moved selectors or load selectors of a tap changer. The apparatus according to the invention furthermore is of low complexity; in particular it has only a few components as well as switches. For example only four switches are required for a design having five regulating voltage levels that can be selected that will be explained in further detail below. These switches can be designed particularly advantageous as an antiparallel thyristor pair or also as a vacuum switching cell.

The invention in the following is to be explained in further detail by means of drawings.

In the drawings:

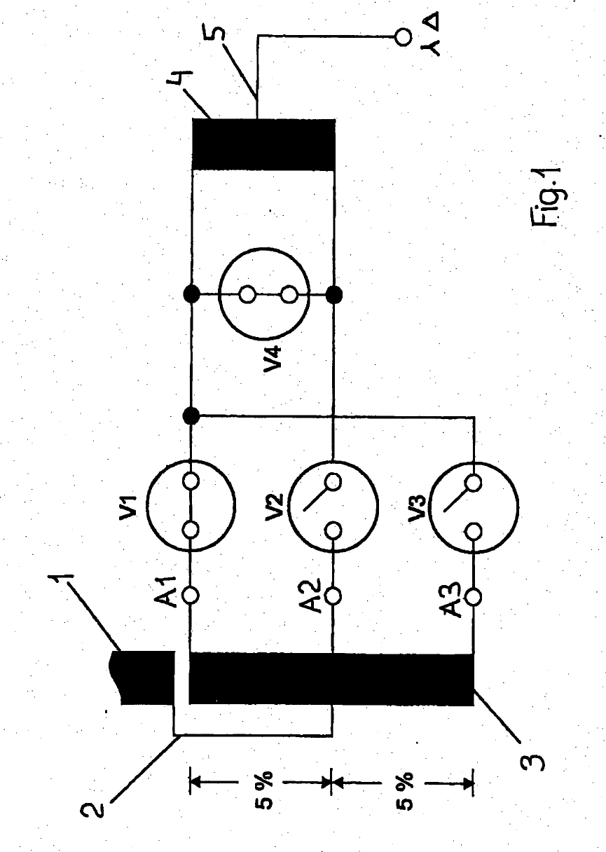

FIG. 1 shows a schematic diagram of a first apparatus according to the invention;

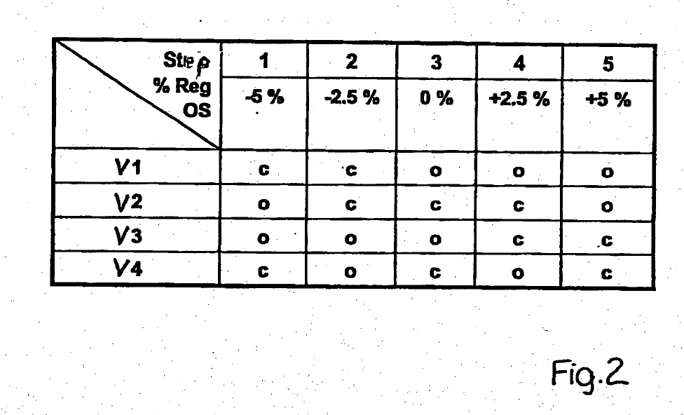

FIG. 2 shows a table of the voltage levels that can be achieved in this apparatus in accordance with the position of the individual circuit elements;

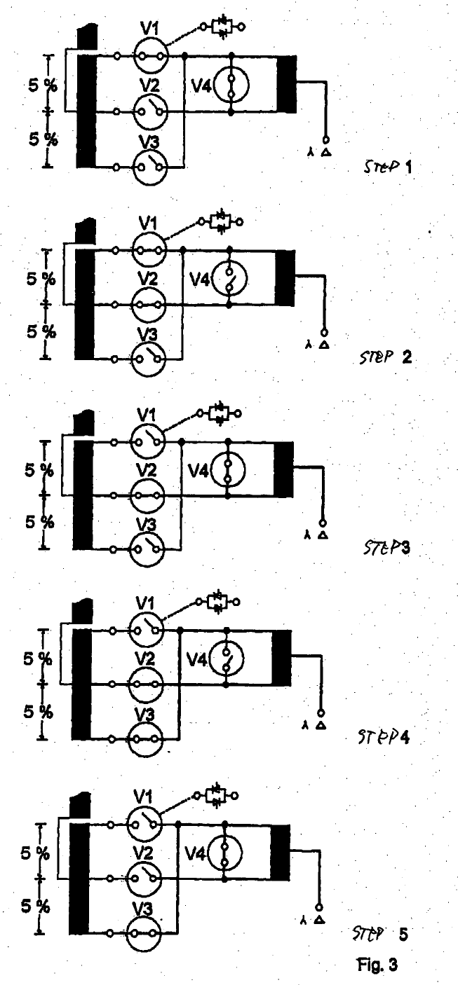

FIG. 3 shows the respective positions of the individual circuit elements at these voltage levels;

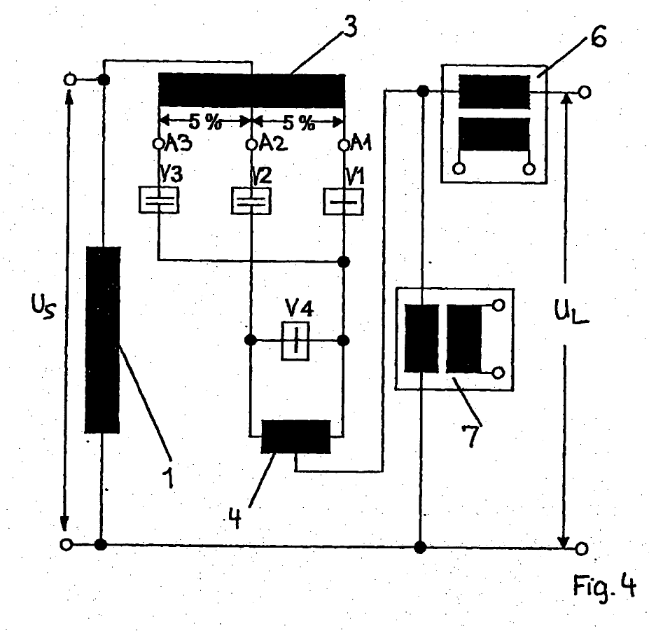

FIG. 4 shows a further apparatus according to the invention for regulating voltage on the load side of a voltage regulator;

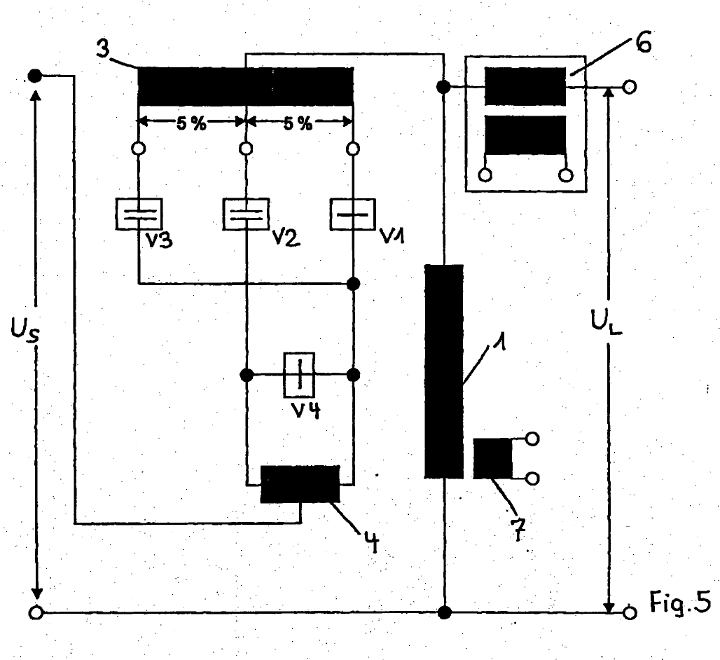

FIG. 5 shows a further apparatus according to the invention for regulating voltage on the primary side of a voltage regulator;

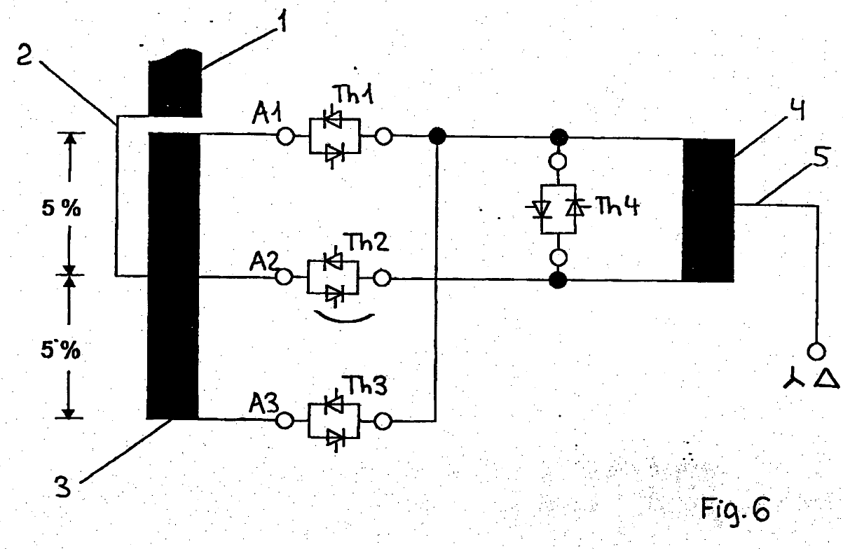

FIG. 6 shows a further apparatus according to the invention having alternatively designed circuit elements;

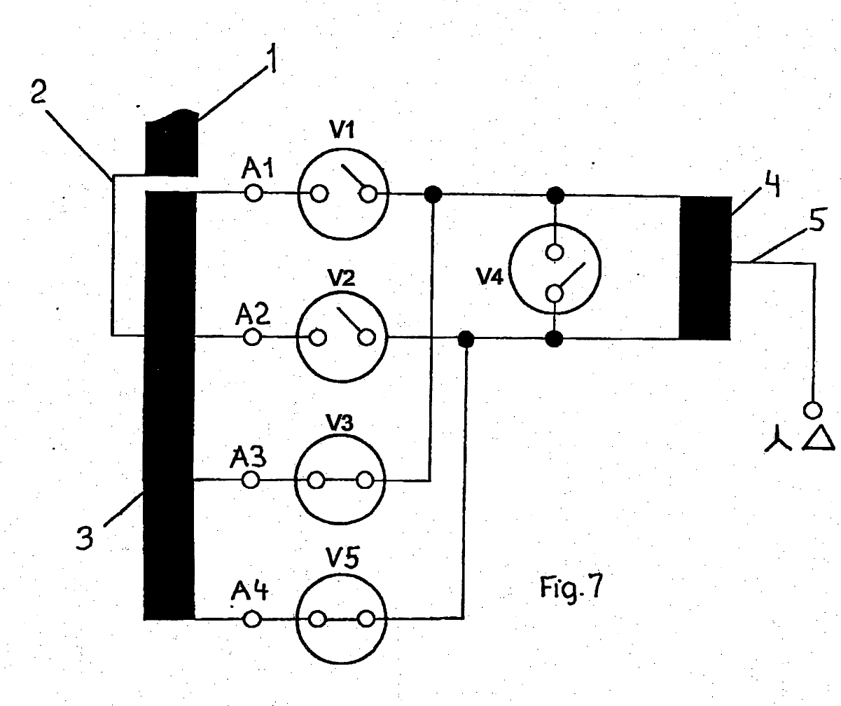

FIG. 7 shows a further apparatus according to the invention with a further developed connection scheme.

In FIG. 1 a first apparatus according to the invention is schematically represented. A primary winding 1 of a control transformer is shown, whose winding end 2 is wired to the center of a separate control winding 3 of the control transformer. The control winding 3 here has three separate taps A1 . . . A3. The taps A1 and A3 are situated at opposite ends of the control winding 3, the tap A2 is exactly in the middle where the connection with the end of the winding 2 of the primary winding 1 is formed. The control winding 3 is dimensioned such that the effective winding lengths between the taps A1 and A2 and between the taps A2 and A3 correspond to 5% of the winding length of the primary winding 1. Of course, other winding lengths are possible as well.

Each of the taps A1 . . . A3 is connected to the input of a circuit element, here a vacuum switch V1 . . . V3. The output of the first vacuum switch V1 that is connected to the tap A1 on the first winding end of the control winding 3, and the output of the second vacuum switch V2 that is connected to the tap A2 in the center of the control winding 3 are directed to both ends of a reactor winding 4; a further circuit element is connected in parallel thereto between the two outputs, here a further vacuum switch V4. The output of the third vacuum switch V3 that is connected to the tap A3 on the other end of the control winding 3 is electrically connected to the output of the first vacuum switch V1. The center of the reactor winding 4 is wired to the output line. For this purpose, a tap 5 is provided on the reactor winding 4.

By operation of the vacuum switches V1 . . . V4, the voltage in this example can be regulated in the range +/−5% in steps of 2.5%.

FIG. 2 shows a table for the example shown in FIG. 1 that illustrates the five different possible voltage levels as a function of the position of the respective vacuum switch V1 . . . V4. Therein, c refers to the closed position (“closed”), whereas o represents the open position of the switch.

It can be seen that these four vacuum switches provide in total five voltage levels. This is due to the fact that on the taps A1 and A3, a voltage is available that differs by +/−5% from the voltage at the tap A2 and that by switching of the reactor winding 4, half of this amount, that is 2.5%, can be superposed.

Control of the vacuum switches V1 . . . V4 is easily possible for example by means of cams, since regardless of the switching direction, toward “higher voltage” or “lower voltage”, a very simple operation sequence results from easy up or down switching.

FIG. 3 shows the different positions of the vacuum switches V1 . . . V4 of the circuit shown in the FIG. 1 and discussed above on the individual voltage levels, as is shown in the table in FIG. 2.

FIG. 4 shows an arrangement according to the invention as a component of a voltage regulator for regulation on the load side. It shows how the input voltage Us is applied to the primary winding 1, the end of which leads to the central tap A2 of the control winding 3. The taps A1 and A3 are connected to respective ends of the control winding 3, again at a winding spacing each of 5% along the primary winding. The positions and functions of the vacuum switches V1 . . . V4 have already been discussed as well as the illustrated reactor winding 4. In addition, a current transformer 6 and a voltage transformer 7 are shown on the load side. Thus, the actual values of current and voltage on the load can be determined in the known manner. By means of a herein unillustrated known controller, a comparison of set value and actual value are compared and as a result, a decision concerning any necessary adjustment that can be a “higher” or “lower” voltage is made. Subsequently, a modification of the switching states of the vacuum switches V1 . . . V4 is made, as shown in FIG. 2. If control of the vacuum switches V1 . . . V4 is effected by means of a cam, rotation of the cams about 72° can be effected for a direction-dependent actuation.

FIG. 5 shows an arrangement according to the invention for regulation on the input (source) side of a voltage regulator. The functional principle is the same as above.

FIG. 6 shows a further arrangement according to the invention, here using antiparallel thyristor pairs Th1 . . . Th4 as circuit elements.

The described circuit elements can within the scope of the invention as described above be vacuum switches as well as mechanical switches or thyristors. The herein discussed design using thyristors has the advantage that the arrangement according to the invention in total results in a fully static switch, without any moving parts. For driving the thyristor Th1 . . . Th4, the table shown in FIG. 2 for example can be easily embodied as electrical control routine.

Within the scope of the invention, it is also possible to extend the circuit arrangement represented in FIG. 1 in a cascade-like manner by providing more than three taps on the control winding 3 and by switching each of these additional taps with a respective switch. An example thereof with only one additional tap A4 is shown in FIG. 7. The control winding 3 in such embodiment is dimensioned such that the winding length between all taps A1 . . . A4 respectively is the same, for example 5% of the winging length of the primary winding 1. Thus, the one skilled in the art can easily calculate the voltage levels that can be additionally achieved according to the invention. This cascade-like principle may be extended as desired.

1. An apparatus for regulating the electrical voltage in power mains by means of a control transformer,
wherein the control transformer in each phase has a primary winding and a separate tapped control winding, and
wherein the individual taps can be switched by circuit elements and can be connected to an output,
characterized in that
the control winding has tree taps,
the first and the third tap each are connected to one end of the control winding and the second tap is connected exactly in a center of the control winding,
the end of the primary winding is connected to the second tap,
the control winding is dimensioned such that the winding length between the first and second taps as well as between the second and third taps are each equal to X% of the winding length of the primary winding, X being a whole number,
the first tap is electrically connected to the input of a first circuit element, the second tap is electrically connected to the input of a second circuit element and the third tap is electrically connected to the input of a third circuit element,
the output of the first circuit element and the output of the second circuit element each are connected to the two ends of a reactor winding,
the output of the third circuit element is electrically connected to the output of the first circuit element,
a further circuit element is connected across the reactor winding and the center of the reactor winding is electrically connected to the output.

2. The apparatus according to claim 1,
characterized in that the value of X is 5.

3. The apparatus according to claim 1,
characterized in that vacuum switches are used as circuit elements.

4. The apparatus according to claim 1,
characterized in that
semiconductor switches, in particular thyristors are used as circuit elements.

5. The apparatus according to one of claims 1,
characterized in that
the control winding has at least one additional tap having a respective further circuit element for increasing the number of possible voltage levels and that is connected in cascade.
